(19) United States
(12) Patent Application Publication
(10) Pub. No.: US 2003/0220146 A1
(43) Pub. Date: Nov. 27, 2003

(54) Device for effecting an elastic coupling and a coupling element

(75) Inventors: Jurgen Bonninger, Sao Paulo (BR); Manfredo York Glaser, Sao Paulo (BR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Vulkan Do Brasil LTDA.

(21) Appl. No.: 10/407,836

(22) Filed: Apr. 4, 2003

(30) Foreign Application Priority Data
Apr. 16, 2002 (BR) PI0201295-2

(51) Int. Cl. F16D 3/78

(52) U.S. Cl. 464/73

(57) ABSTRACT

A device for effecting an elastic coupling is provided, comprising a first moving coupling element associable to a second movable coupling element, the first moving element transmitting rotational movement to the second movable element by compression of an elastic element, the coupling device defining a vent for the elastic element. Such an elastic coupling device thereby allows an increase in capacity of torque transmitted with respect to a similar coupling device lacking a vent, thereby maintaining the same useful life and reliability, and providing capital economy through utilization thereof.

### BACKGROUND OF THE INVENTION

1. Field of the Invention

The present invention relates to a device for effecting an elastic coupling, particularly for transmitting rotation and power between two out-of-line axles, and a coupling element for use therewith.

2. Description of Related Art

Conventionally, couplings are devices designed for joining rotatable axles that are axially out-of-line and may represent parallel axles, but do not define a single straight line, or axles that are not parallel to each other, or still a combination of the two possibilities.

In order to bring about circular movements between axles in these conditions, the elastic coupling devices have a first end associated to a first axle and a second end, independent of the first axle, associated to a second axle. Both ends of the coupling device are interconnected by means of a flexible element or component, such as one made of rubber or any other natural or synthetic material having elastic properties and allowing rotational movement to be transmitted from one end of the coupling to the other (and consequently from one axle to the other). This transmission is possible since the elastic element deforms continuously, contracting and expanding each section, as it turns so as to dissipate vibration.

However, this repetitive movement causes heating, aging, wearing and fatigue of the elastic element, which is aggravated when some adverse conditions occur, mainly if such adverse conditions are combined, namely:

(i) the faster the rotation, the greater the vibration to which the coupling device is subjected and the more intense the heat that will be generated by the internal damping of the elastic element, which causes more rapid aging, wearing and fatigue;

(ii) the greater the vibratory load (or vibratory torque) transmitted by the coupling device, the higher working temperature which will be reached and, consequently, the more intense heat will be generated, which causes more rapid aging, wearing and fatigue of the elastic element;

(iii) the greater the vibratory torque and the out-of-line condition between the axles, the greater the generation of heat due to the friction between the surfaces of the elastic element and the claws of the coupling device, which causes more rapid aging, wearing and fatigue of the elastic element;

(iv) the lesser the exposition of the elastic element to contact with the ambient air, the lesser its capacity for dissipating heat, which will cause a reduced useful life.

These adverse working conditions of the coupling device which are reached, often even simultaneously/cumulatively, cause in practice a reduced useful life of the elastic element, occasioning frequent stoppages for replacement thereof, thus causing higher and frequent manufacturing costs with the consequent loss of productivity.

With a view to eliminate the drawback of reduced useful life of the elastic element, due to the high working temperature, coupling devices provided with vents have been developed in order to provide the elastic element with contact with air at room temperature, which allows the heat to be dissipated to reduce the functioning temperature and a consequent increase in useful life. In this regard, a few references relating to elastic coupling devices designed for this purpose have been cited herein.

U.S. Pat. No. 4,734,079 discloses a torsional and lateral vibration absorber, which is used on internal combustion engine. The elastic element is subject to tangential loads that cause shearing strains. Channels were made, which bring about an increase in the absorbing capacity, and there is the possibility of including radial channels in one of the faces that will work as a fan.

U.S. Pat. No. 4,790,791 discloses an elastic coupling, particularly for use on diesel engines, the elastic element being subject only to torsion. This coupling is composed of an elastic element vulcanized between two (internal, external) rings. When in operation, the heat dissipation occurs through the side surfaces. When an air clutch is used, a hot-air chamber is formed, which makes necessary to provide vents.

U.S. Pat. No. 4,929,115 and U.S. Pat. No. 5,066,263 disclose elastic couplings, also particularly for use on diesel engines, wherein a hot-air chamber is formed between the air clutch and the coupling, which makes necessary to provide vents. These couplings are composed mainly of elastic elements vulcanized between side rings. There are side perforations that act in distributing internal heat and removing heat from the engine, thus rendering the operation temperature of the system uniform.

DE 198 46 873 and DE 199 55 049 disclose elastic elements that are subject only to torsion, being used on diesel engines. These couplings are composed mainly of an elastic element vulcanized between two side rings. There are side perforations that remove the heat from the chamber formed between the fixation flange and the internal part. These perforations function as vents between the engine and the coupling.

U.S. Pat. No. 6,293,871 discloses an elastic coupling having an elastic element that is subject only to shearing strains, being used on internal combustion engines. This coupling is composed mainly of elastic elements vulcanized between side (internal, external) rings. There are side perforations that remove the heat from the chamber formed between the fixation flange and the internal part. These perforations function as vents between the engine and the coupling.

JP 11101261 discloses an elastic coupling that is subject only to compression by the claws. In order to alleviate the internal temperature generated by the damping of the elastic element, external flaps and channels have been provided, to increase the exchange of heat with the environment. These flaps and channels actuate indirectly, reducing the temperature of the outer surface of the metallic parts.

With exception of JP 11101261, in none of the above-commented documents of the prior art does the elastic element have teeth or grooves that enable it to function under compression. The coupling device disclosed in the Japanese document, in turn, has external channels and flaps that enlarge the area of the outer surface of the coupling device, thus functioning to provide a greater transfer of heat from the coupling device to the environment. However, this capacity of transmitting heat is limited, since no vent channel is provide for an effective removal/transfer of heat from the elastic element to the environment. Therefore, for the couplings that function by compression, the problem of heat dissipation still had not been solved.

Thus, there exists a need for a device for elastic coupling, the elastic element of which works under compression and which is provided with ventilation, which results in a long useful life and greater capacity of torque transmission as compared to conventional coupling devices. Accordingly, there also exists a need for a coupling element for effecting such a coupling device.

### BRIEF SUMMARY OF THE INVENTION

The above and other needs are met by the present invention which, in one embodiment, provides a device for effecting an elastic coupling, comprising a first moving coupling element associable to a second movable coupling element, the first moving element transmitting rotational movement to the second movable element by compression of an elastic element, whereby the elastic element is ventilated.

Other embodiments of the present invention provide a ventilated coupling element, particularly for use on a device for effecting an elastic coupling as disclosed herein.

Embodiments of the present invention also provide a device for elastic coupling that works by compression, which, since the elastic element is ventilated, results in an increase of the capacity of transmitted torque, with respect to a similar coupling device without ventilation, thereby maintaining the same useful life and reliability and providing capital economy from utilization thereof.

### BRIEF DESCRIPTION OF THE SEVERAL VIEWS OF THE DRAWING(S)

The present invention will now be described in greater detail with reference to the accompanying drawings, wherein:

FIG. 1 shows a side view of a first embodiment of the device for effecting an elastic coupling according to the present invention;

FIG. 2 shows a cross-section side view of the device illustrated in FIG. 1;

FIG. 3 shows a detail view of a ventilation bore of the device illustrated in FIGS. 1 and 2;

FIG. 4 shows a back view of the device illustrated in FIGS. 1-3;

FIG. 5 shows a front view of the device illustrated in FIGS. 1-4;

FIG. 6 shows a perspective view of a first embodiment of the elastic element of the device illustrated in FIGS. 1-5;

FIG. 7 shows a perspective view of a second embodiment of an elastic element of a device for effecting an elastic coupling according to the present invention;

FIG. 8 shows a front view of the elastic element illustrated in FIG. 7;

FIG. 9 shows a perspective view of a third embodiment of an elastic element of the device for effecting an elastic coupling according to the present invention;

FIG. 10 shows a front view of the elastic element illustrated in FIG. 9;

FIG. 11 shows a perspective view of a fourth embodiment of an elastic element of the device for effecting an elastic coupling according to the present invention; and

FIG. 12 shows a front view of the elastic element illustrated in FIG. 11.

### DETAILED DESCRIPTION OF THE INVENTION

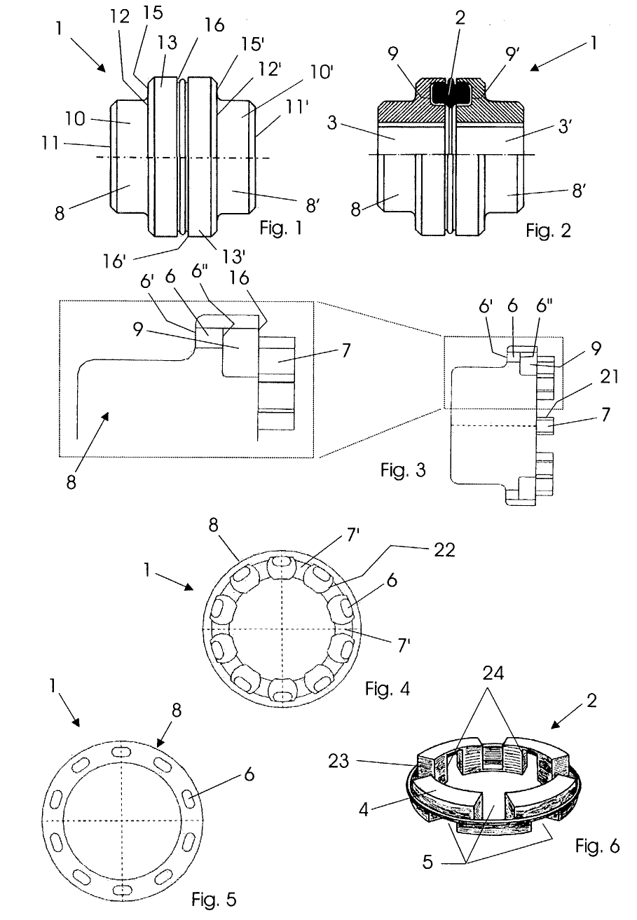

As shown in FIGS. 1-6, a device 1 for effecting an elastic coupling according to the present invention comprises a first moving coupling element 8, which is associated with a rotatable (gyrant) axle (not shown), an elastic element 2, and a second movable coupling element 8′ associated with a rotatable axle (not shown). In order for the device 1 to be necessary, the gyrant and rotatable axles must be axially out-of-line, and may represent parallel axles that do not define a single straight line or axles that are not parallel to each other, or still a combination of the two possibilities.

The elastic element 2 functions as a joint, enabling transmission of the rotation movement from the gyrant axle to the rotatable axle. This transmission of rotation movement is possible, since the elastic element 2 deforms continuously as it turns, absorbing vibrations.

The first moving element 8 comprises a first substantially cylindrical portion 10 having a closed main surface 11 facing the gyrant axle and a second closed main surface 12 parallel to the first closed main surface 11, from which a second portion 13 projects, which is also substantially cylindrical and concentric to the first portion 10, but has a larger diameter. The area of the second main surface corresponds to the difference in diameter between the first cylindrical portion (smaller) and the second cylindrical portion (larger) and its shape is that of a circular ring 15.

Optionally, the first moving element 8 may comprise a first axial through bore 3 for accommodating the tip or end of the gyrant axle, but another type of fixation between axle and element 8 may be foreseen.

The free surface 16 of the second portion 13, opposed to that from which this portion projects, comprises at least one first projection 7 for transmission of movement. Preferably, this first projection 7 is substantially shaped as a parallelepiped having a trapezoidal cross-section, comprising two conical opposite side surfaces, but it may have any other shape, provided that it enables transmission of rotational movement, as will be described later. This shape allows the elastic element 2 to adhere to the surface in a better manner, positioning it in a better way and minimizing wearing.

The second movable element 8′ comprises a third substantially cylindrical portion 10′, which has a third closed main surface 11′ facing the rotatable axle and a fourth closed main surface 12′ parallel to the third closed main surface 11′, from which a fourth portion 13′ projects, which is also substantially cylindrical and concentric to the third portion 10′, but has a larger diameter. The area of the fourth main surface corresponds to the difference in diameter between the third cylindrical portion (smaller) and the fourth cylindrical portion (larger) and its shape is that of a circular ring 15′.

Optionally, the second movable element 8′ may comprise a second axial through bore 3′ for accommodating the tip or end of the rotatable axle, but another type of fixation between axle and element 8′ may be foreseen.

The free surface 16′ of the fourth portion 13′, which is opposed to that from which this portion projects, comprises at least one second projection 7′ for transmission of movement. Preferably, this second projection 7′ is shaped substantially as a parallelepiped having a trapezoidal cross-section, comprising two conical opposite side surfaces, but any other shape may be foreseen, since it enables the transmission of rotation movement, as will be described later.

Complementing the description, the first projection 7 has a first face 21, and the second projection 7′ has a second face 22.

Both the first moving element 8 and the second movable element 8′ comprise respective first and second cavities 9, 9′ for positioning the elastic element 2, these cavities being substantially annular in shape and concentric to the element 8, 8′ in which they are comprised. Alternatively, the cavities 9, 9′ may assume another shape or simply they may not be provided.

The moving element 8 and movable element 8′ of the preferred embodiment are designed in such a manner that the respective first and second projections 7, 7′ extend from the first and second cavities 9, 9′.

In addition, at least one of the first moving element 8 and second movable element 8′ includes at least one vent 6 for the elastic element 2, which in the preferred embodiment has the shape of a longitudinal vent through bore 6, parallel to the first and second elements 8, 8′, since the direction of its axial length is substantially parallel to the direction of the axial length of said elements 8, 8′.

The through bore 6 has a first end 6′ facing outwards, located on the circular ring 15, 15′, and a second end 6″ facing the respective first and second cavities 9, 9′, thus enabling air flow at room temperature to the elastic element 2, so that it can work at lower temperatures, thus extending its useful life, as it will be described later.

The number of bores 6 may vary, as well as their shape and positioning, as long as they enable the correct ventilation of the elastic element 2.

The elastic element 2 will be readily appreciated by one skilled in the art. Such an elastic element 2 is made mainly from rubber and is substantially annular in shape, although it may be made from appropriate materials other than rubber depending on the applicable requirements. In order to enable it to engage with the device 1, recesses 5 are provided for transmission of movement, in a number equal to the sum of first and second projections 7, 7′.

Thus, in the first preferred embodiment, the elastic element 2 has at least two semicylindrical recesses 5, axially aligned therewith, namely:

(i) a recess 5 located in a first surface of the elastic element 2 and cooperating with the first projection 7 located on the first moving element 8, and

(ii) a recess 5 located in a second surface of the elastic element 2 and cooperating with the second projection 7′ located on the second movable element 8′.

The recess 5 that cooperates with the first projection 7 has a third contact face 23, and the recess 5 that cooperates with the second projection 7′ has a fourth contact face 24.

When the device 1 is mounted, the gyrant axle associated to the first moving element 8 causes the latter to rotate. In this way, the first face 21 of the first projection 7 compresses the third contact face 23 of the recess 5 that cooperates with the first projection 7 and, thus, the elastic element 2 will also move rotationally. Immediately following the beginning of the movement of the elastic element 2, the fourth face 24 of the recess 5 that cooperates with the second projection 7′ compresses the second contact face 22 of the second projection 7′. In this way, the elastic element 2 works predominantly by compression, to transmit the rotation movement. Due to its elasticity, the elastic element 2 can withstand out-of-line conditions between the gyrant axle and the rotatable axle. When the device 1 is transmitting rotation movement, the rotation itself will produce an air flow at room temperature, which passes through the vent through bores 6, enabling transfer of heat from the elastic element 2 to the air, which considerably increases its useful life.

In a first preferred embodiment, the present invention has ten first projections 7, arranged symmetrically to each other, and ten second projections 7′, also arranged symmetrically. In order to enable the correct functioning of the device 1, the elastic element 2 of the preferred embodiment comprises twenty recesses 5, ten recesses 5 being located in a first surface of the elastic element 2 and cooperating with the ten first projections 7 located on the first moving element 8, and ten recesses 5 located in a second surface of the elastic element 2 and cooperating with the second projections 7′ located on the second movable element 8′.

In addition, since the through bore has a first end 6′ facing outwards and a second end 6″ facing the respective first and second cavities 9, 9′, ten vent through bores 6 are provided in the first moving element 8, and ten vent through bores 6 in the second movable element 8′.

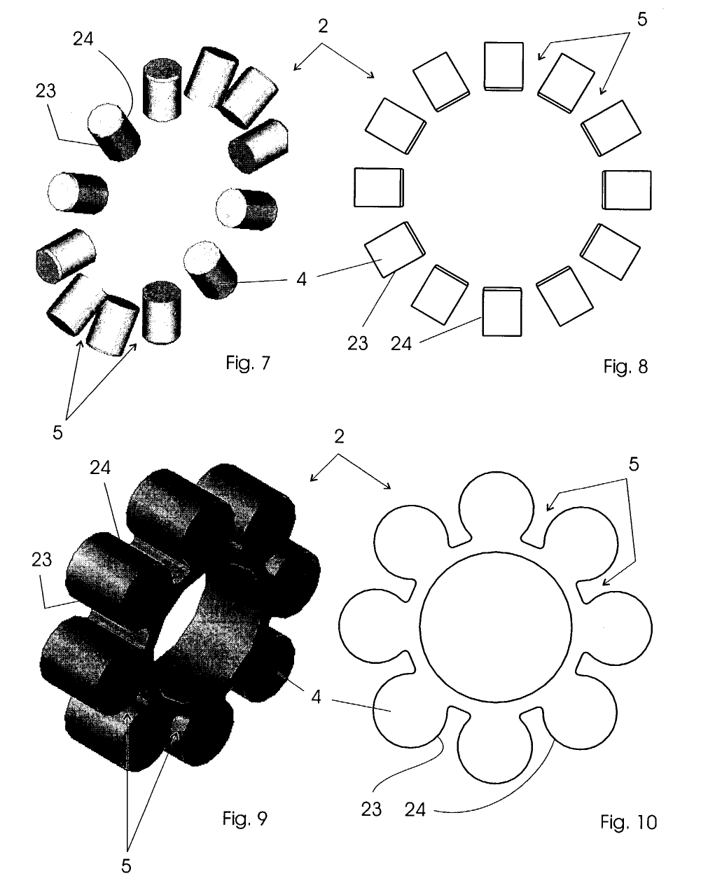

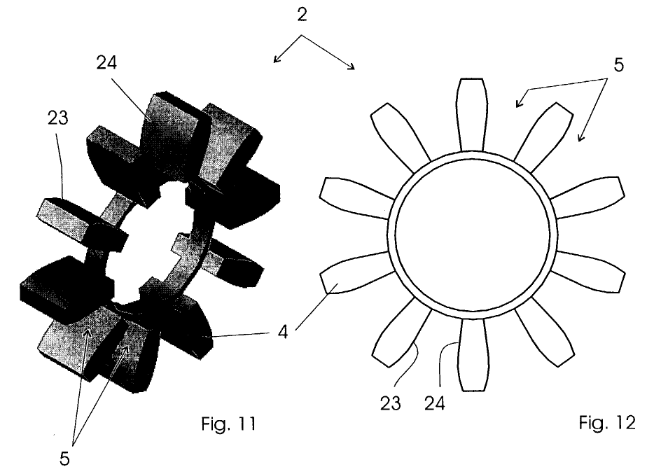

As already mentioned, the elastic element 2 may have different shapes. As shown in FIGS. 7 and 8, a second preferred embodiment of the elastic element 2 includes twelve elastomeric cylinders arranged radially, with their axial lengths converging to the center of the circumference determined by them, so that the twelve angular distances between them play the role of twelve recesses 5. As shown in FIGS. 9 and 10, a third embodiment of the elastic coupling 2 has eight parallelepiped-shaped recesses 5, and a fourth embodiment, as shown in FIGS. 11 and 12, has ten parallelepiped-shaped recesses 5 having a trapezoidal cross-section.

By virtue of this heat exchange, which enables the elastic element 2 to work with lower constant temperatures, there are various advantages, which may even be combined, namely:

due to the increase in useful life of the elastic element 2, one can transmit the same torque transmitted by a conventional coupling device having the same capacity with a considerably longer useful life;

one can transmit the same torque transmitted by a conventional coupling device by a coupling device as described herein, which may be smaller and lighter, without shortening the useful life with respect to the conventional equipment, but with an important reduction in acquisition cost and gain in mechanical efficiency, by virtue of less weight and increase in inertia of the smaller device, which makes possible a reduction in the consumption of both electricity and fuel;

one can transmit a greater torque than that possible with a conventional coupling device having the same capacity, without shortening the useful life with respect to it, which results in lower costs for implementation of the equipment, since the conventional coupling device having a greater capacity comprises an elastic element that is more expensive and has a greater inertia moment, thus entailing greater mechanical losses;

one can dismount the coupling device more easily, by using the vents 6 to push the elastic element 2 out of the cavity;

one can verify the tearing/break of the elastic element 2 without the need to dismount the coupling device;

there may be a situation in which the advantages combine with one another, bringing even more advantages for the user.

Evidently, the shape, geometry and number of projections 7, 7′ and of recesses 5 may vary, as already mentioned. This variation may be very broad, since the only condition for the device to be incorporated in the protection scope of the present invention is that it must have an elastic element 2 that works by compression and a vent 6 for ventilation of the elastic element 2. So, any constructive geometry that has these two characteristics is embraced by the accompanying claims. For the same reason, the shape of the moving and movable elements 8, 8′ may vary too.

A preferred embodiment having been described, it should be understood that the scope of the present invention embraces other possible variations, being limited only by the contents of the accompanying claims, which include the possible equivalents.

That which is claimed:

1. An elastic coupling device, comprising:
a moving coupling element adapted to operably engage a gyrant axle;
a movable coupling element adapted to operably engage a rotatable axle;
an elastic element operably engaged between the moving and movable coupling elements and being adapted to transmit rotation from the gyrant axle to the rotatable axle through compression of the elastic element; and
a vent defined by at least one of the moving and movable coupling elements and being configured to provide ventilation for the elastic element.

2. An elastic coupling device according to claim 1 wherein the vent further comprises at least one through bore defined by at least one of the moving and movable coupling elements, the at least one through bore extending to the elastic element so as to provide ventilation therefor.

3. An elastic coupling device according to claim 1 wherein at least one of the moving and movable coupling elements defines a cavity corresponding to and capable of receiving at least a portion of the elastic element so as to facilitate positioning of the elastic element between the moving and movable coupling elements.

4. An elastic coupling device according to claim 3 wherein the vent extends to the cavity so as to ventilate the portion of the elastic element received thereby.

5. An elastic coupling device according to claim 1 wherein each of the moving and movable coupling elements defines an axis and the vent extends to the elastic element generally parallel to the axis of the one of the moving and movable coupling element defining the vent.

6. An elastic coupling device according to claim 1 wherein each of the moving and movable coupling elements defines a projection corresponding to and capable of being received by a corresponding recess defined by the elastic element.

7. An elastic coupling device according to claim 6 wherein each of the projections defined by the moving coupling element include a first contact face configured to operably engage a third contact face defining the corresponding recess in the elastic element in a direction of rotation and each of the projections defined by the movable coupling element include a second contact face configured to operably engage a fourth contact face defining the corresponding recess in the elastic element opposite to the direction of rotation, whereby compression between the first and third contact faces and between the fourth and second contact faces facilitates transmission of rotation from the gyrant axle to the rotatable axle via the moving and movable coupling elements.

8. An elastic coupling device according to claim 1 wherein the elastic element comprises a ring generally defining opposed transverse surfaces, the ring being configured such that the recesses defined by one transverse surface for engaging the projections defined by the moving coupling element are angularly displaced with respect to the recesses defined by the other transverse surface for engaging the projections defined by the movable coupling element.

9. An elastic coupling device according to claim 1 wherein the elastic element comprises a plurality of cylindrical elements, each cylindrical element defining an axis, the cylindrical elements being angularly separated so as to define recesses therebetween and arranged with the axes thereof extending radially outward.

10. An elastic coupling device according to claim 1 wherein the elastic element comprises a plurality of cylindrical elements, each cylindrical element defining an axis, the cylindrical elements being arranged with the axes thereof extending substantially parallel to each other, the cylindrical elements being angularly-separated so as to define recesses therebetween and being interconnected so as to form a ring.

11. An elastic coupling device according to claim 1 wherein the elastic element comprises a plurality of angularly-separated geometric elements defining recesses therebetween, the geometric elements being interconnected so as to form a ring.

12. A coupling element of an elastic coupling device adapted to transmit rotation from a gyrant axle to a rotatable axle through compression of an elastic element, the coupling element being adapted to be operably engaged between the elastic element and at least one of the gyrant axle and the rotatable axle, said coupling element comprising:
a vent defined by the coupling element and configured to provide ventilation for the elastic element.

13. A coupling element according to claim 12 wherein the vent further comprises at least one through bore defined by the coupling element and extending to the elastic element so as to provide ventilation therefor.

14. A coupling element according to claim 12 wherein the coupling element defines a cavity corresponding to and capable of receiving at least a portion of the elastic element so as to facilitate positioning of the elastic element with respect thereto.

15. A coupling element according to claim 14 wherein the vent extends to the cavity so as to ventilate the portion of the elastic element received thereby.

16. A coupling element according to claim 12 wherein the coupling element defines an axis and the vent extends to the elastic element generally parallel to the axis.

17. A coupling element according to claim 12 wherein the coupling element defines a projection corresponding to and capable of being received by a corresponding recess defined by the elastic element.

18. A coupling element according to claim 17 wherein each of the projections defined by the coupling element includes a contact face configured to operably engage a contact face defining the corresponding recess in the elastic element, whereby compression between the respective contact faces facilitates transmission of rotation from the gyrant axle to the rotatable axle via the coupling element.
